(19) United States
(12) Patent Application Publication
(10) Pub. No.: US 2025/0111661 A1
(43) Pub. Date: Apr. 3, 2025

(54) DUAL FORMULATION FOR A COMPUTER VISION RETENTION MODEL

(71) Applicant: NVIDIA Corporation, Santa Clara, CA (US)

(72) Inventors: Ali Hatamizadeh, Los Angeles, CA (US); Michael Ranzinger, Park City, UT (US); Jan Kautz, Lexington, MA (US)

(21) Appl. No.: 18/882,629

(22) Filed: Sep. 11, 2024

Related U.S. Application Data
(60) Provisional application No. 63/542,256, filed on Oct. 3, 2023.

(51) Int. Cl. G06V 10/82; G06V 10/26; G06V 10/774; G06V 10/776; G06V 10/94

(52) U.S. Cl. CPC G06V 10/82; G06V 10/26; G06V 10/774; G06V 10/776; G06V 10/955

(57) ABSTRACT

Transformers are neural networks that learn context and thus meaning by tracking relationships in sequential data. The main building block of transformers is self-attention which allows for cross interaction among all input sequence tokens with each other. This scheme effectively captures short-and long-range spatial dependencies and imposes time and space quadratic complexity in terms of the input sequence length, which enables their use with Natural Language Processing (NLP) and computer vision tasks. While the training parallelism of transformers allows for competitive performance, unfortunately the inference is slow and expensive due to the computational complexity. The present disclosure provides a computer vision retention model that is configured for both parallel training and recurrent inference, which can enable competitive performance during training and fast and memory-efficient inferences during deployment.

### CLAIM OF PRIORITY

This application claims the benefit of U.S. Provisional Application No. 63/542,256 (Attorney Docket No. NVIDP1387+/23-SC-0871US01) titled “VISION RETENTION NETWORK,” filed Oct. 3, 2023, the entire contents of which is incorporated herein by reference.

### TECHNICAL FIELD

The present disclosure relates to computer vision models.

### BACKGROUND

During the recent years, transformers and their variants have shown competitive performance across multiple domains such as Natural Language Processing (NLP) and computer vision. Generally, transformers are neural networks that learn context and thus meaning by tracking relationships in sequential data. The main building block of transformers is self-attention which allows for cross interaction among all input sequence tokens with each other. This scheme effectively captures short-and long-range spatial dependencies and imposes time and space quadratic complexity in terms of the input sequence length.

While the training parallelism of transformers allows for competitive performance, unfortunately the inference is slow and expensive due to the computational complexity. Recently, some solutions have been proposed to enable both training parallelism and fast recurrent inference. However, these solutions have been limited to the autoregressive text generation space.

There is a need for addressing these issues and/or other issues associated with the prior art. For example, there is a need for a computer vision retention model that is configured for both parallel training and recurrent inference, which can enable competitive performance during training and fast and memory-efficient inferences during deployment.

### SUMMARY

A method, computer readable medium, and system are disclosed for a computer vision model having dual parallel and recurrent formulations. An input representation of an image is processed to generate an encoded representation of the image. The processing is performed using a retention encoder of a computer vision model operating in accordance with a first formulation that includes at least in part a recurrent formulation. The computer vision model has been trained with the retention encoder operating in accordance with a second formulation that is a parallel formulation. The encoded representation of the image is processed, using a multilayer perceptron (MLP) of the computer vision model, to generate an output particular to a defined computer vision task.

### BRIEF DESCRIPTION OF THE DRAWINGS

FIG. 1 illustrates an inference-time method of a computer vision model having dual parallel and recurrent formulations, in accordance with an embodiment.

FIG. 2 illustrates a method to train and deploy a computer vision model having dual parallel and recurrent formulations, in accordance with an embodiment.

FIG. 3 illustrates an architecture of a computer vision model having dual parallel and recurrent formulations, in accordance with an embodiment.

FIG. 4 illustrates an architecture of the retention encoder of the computer vision model of FIG. 3, in accordance with an embodiment.

FIG. 5A illustrates inference and/or training logic, according to at least one embodiment;

FIG. 5B illustrates inference and/or training logic, according to at least one embodiment;

FIG. 6 illustrates training and deployment of a neural network, according to at least one embodiment;

FIG. 7 illustrates an example data center system, according to at least one embodiment.

### DETAILED DESCRIPTION

The present disclosure relates to a computer vision model having dual formulations, as described below. The computer vision model refers to a machine learning model that is configured to perform a computer vision task. A computer vision task refers to a task performed with respect to an image or a video comprised of a sequence of frames (images). For example, the computer vision task may include processing an image or video for object detection and instance segmentation. As another example, the computer vision task may include processing an image or video for semantic segmentation.

The computer vision model includes a retention encoder that is configured to operate in accordance with one formulation at training-time and another formulation at inference-time (e.g. during deployment). The retention encoder refers to a functional component of the computer vision model that is configured to encode a given image representation (which can include a video frame). The retention encoder may be configured to process a given image that is in a first representation and to encode the given image into a second (encoded) representation.

With respect to the dual formulated computer vision model, a formulation refers to a process and/or configuration of the computer vision model. With respect to the present description, the training-time formulation is a parallel formulation. During processing of an input at training-time, the parallel formulation computes retention without regard to at least one previous state. In an embodiment, the parallel formulation may process all tokens simultaneously. This parallel formulation enables parallel training of the model with competitive performance (e.g. with output quality comparative to computer vision models having only a parallel formulation used for both training and inference processes).

Also with respect to the present description, the inference-time formulation at least in part includes a recurrent formulation. In an embodiment, the inference-time formulation may be only a recurrent formulation. In another embodiment, the inference-time formulation may be a combination of recurrent and parallel formulations, also referred to herein as a hybrid recurrent/parallel formulation or a “chunkwise” formulation. During processing of an input at inference-time, the recurrent formulation computes retention based on at least one previous state. In an embodiment, the recurrent formulation may only depend on a previous token to make a next token prediction. Employing the recurrent formulation (whether singularly or in the hybrid mode) at inference-time speeds up the inference of the model thereby providing improved throughput of the model while also reducing memory consumption (e.g. when compared with computer vision models employing the parallel formulation for the inference process).

The embodiments described below will refer to the dual formulated computer vision model described above.

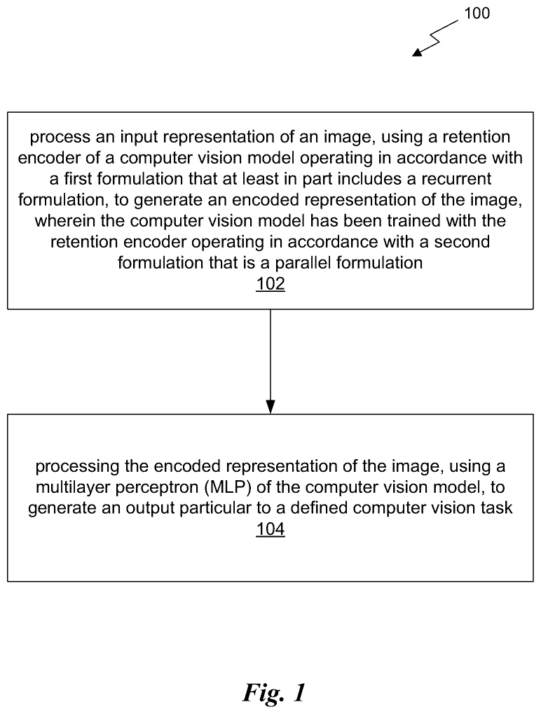

FIG. 1 illustrates an inference-time method 100 of a computer vision model having dual parallel and recurrent formulations, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, an input representation of an image is processed using a retention encoder of a computer vision model operating in accordance with a first formulation to generate an encoded representation of the image. With respect to the present method 100, the first formulation includes at least in part a recurrent formulation, or in other words may be a recurrent-only formulation or a hybrid recurrent/parallel formulation. Thus, the retention encoder may, at least in part, compute retention based on at least one previous state when processing the input representation of the image to generate the encoded representation of the image.

For example, for the recurrent-only formulation, the retention encoder may compute retention within the input representation of the image by maintaining previous internal states. As another example, for the hybrid recurrent/parallel formulation, the input representation of the image may be apportioned into a plurality of portions, and the retention encoder may use a parallel formulation (e.g. without maintaining previous internal states) to compute retention between the plurality of portions and may use the recurrent formulation (e.g. with maintaining previous internal states) to compute retention within each portion of the plurality of portions.

In an embodiment, the retention encoder may operate in accordance with the recurrent-only formulation when processing of the input representation of the image by the retention encoder satisfies a performance criteria. In an embodiment, the retention encoder may operate in accordance with the hybrid recurrent/parallel formulation when processing of the input representation of the image by the retention encoder does not satisfy the performance criteria. The performance criteria may include memory usage or throughput of processing the input representation of the image. The performance criteria may be estimated based on a sequence length of the input representation of the image.

The input representation of the image refers to a representation that has been generated from the image and that the retention encoder of the computer vision model is configured to be able to process. In an embodiment, the input representation of the image may be a sequence of patch and position embeddings having a class token appended at an end of the sequence. For example, to generate the input representation of the image, the image may be apportioned into a plurality of flattened patches, the flattened patches may be linearly projected into a patch embedding, a position embedding may be added to the patch embedding (e.g. to provide a representation of the position of each patch in the image) thereby resulting in a sequence of patch and position embeddings, and a class token may be appended to the sequence of patch and position embeddings. In an embodiment, the class token may define a class (e.g. category) of an object represented in the image.

The encoded representation of the image that is generated by the retention encoder of the computer vision model refers to a representation that encodes information associated with the image which has been learned by the computer vision model. In an embodiment, the encoded representation of the image may include a retention map. In an embodiment, the encoded representation of the image (e.g. the retention map) may localize salient image features. In an embodiment, the encoded representation of the image (e.g. the retention map) may capture short-range spatial dependencies and/or long-range spatial dependencies.

In an embodiment, the retention encoder may include a multi-head retention component. In an embodiment, the multi-head retention component may use a causal retention decay mask. In an embodiment, the retention encoder may include at least one layer comprised of a multi-head retention component and a multilayer perceptron (MLP) component. In an embodiment, the retention encoder may include a plurality of layers each comprised of the multi-head retention component and the MLP component.

In an embodiment, the retention encoder may be configured for one-dimensional (1D) retention. In an embodiment, for the 1D retention, decay between successive patches of the image along a column of the image is increased by a constant factor γ (gamma), regardless of the number of patches per row in the image. In an embodiment, the retention encoder may be configured for two-dimensional (2D) retention. In an embodiment, for the 2D retention, decay accumulates across both horizontal and vertical patches of the image, compounding based on their combined distances.

In operation 104, the encoded representation of the image is processed, using a MLP of the computer vision model, to generate an output particular to a defined computer vision task. In an embodiment, the MLP may be a final MLP module in a sequences of processing blocks of the computer vision model. In other words, the MLP that processes the encoded representation of the image may be configured to perform a defined computer vision task to generate a particular output from the encoded representation of the image. In an embodiment, the defined computer vision task is object detection and instance segmentation. In an embodiment, the defined computer vision task is semantic segmentation.

It should be noted that, as initially mentioned above, the computer vision model described herein has been trained with the retention encoder operating in accordance with a parallel formulation. Thus, while parallel training has been employed for the computer vision model, the subsequent inference-time method 100 alternatively relies on a full or partial recurrent formulation for the retention encoder. Further embodiments will now be provided in the description of the subsequent figures. It should be noted that the embodiments disclosed herein with reference to the method 100 of FIG. 1 may apply to and/or be used in combination with any of the embodiments of the remaining figures below.

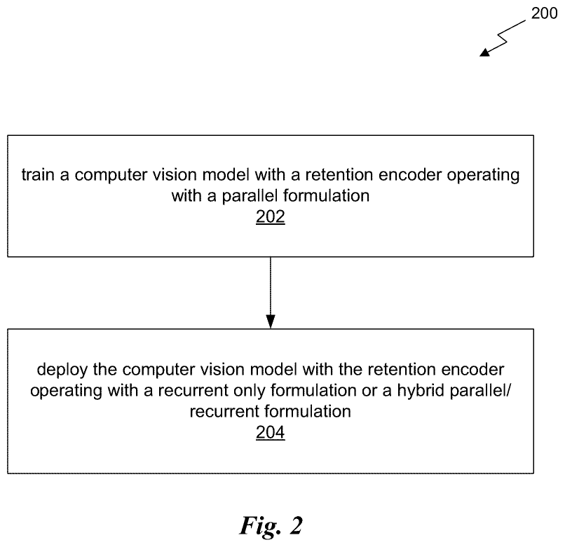

FIG. 2 illustrates a method 200 to train and deploy a computer vision model having dual parallel and recurrent formulations, in accordance with an embodiment. The computer vision model is specifically configured to process an image or video to generate an output. The processing includes performing some computer vision task. In an embodiment, the computer vision task may be classification and the output may be a classification for the image. In an embodiment, the computer vision task may be object detection and instance segmentation and the output may be a classification of an object in the image and information defining a location of the object in the image. In an embodiment, the computer vision task may be semantic segmentation and the output may be a pixel-wise classification in the image.

In operation 202, the computer vision model is trained with a retention encoder operating with a parallel formulation. The parallel formulation computes retention without regard to at least one previous state. The training may be performed using a training dataset of labeled images.

In operation 204, the computer vision model is deployed with the retention encoder operating with a recurrent only formulation or with a hybrid recurrent/parallel formulation. The recurrent formulation computes retention based on at least one previous state. The deployment includes using the computer vision model to infer an output for a given image representation. The deployment may be performed in accordance with the method 100 of FIG. 1.

### 1D Retention

In an embodiment, the retention encoder may be configured for 1D retention. For example, an input sequence X ∈ [symbol] ^{|x×D} will be encoded in an autoregressive manner. Given the query (qₙ), key (kₙ) and value (Vₙ) in state sₙ, this sequence-to-sequence mapping can be written per Equation 1.

$${s}_{n} = γ {s}_{n - 1} + {k}_{n}^{⊤} {v}_{n} , \qquad Equation 1$$

$$Ret ( {X}_{n} ) = {q}_{n} {s}_{n} ,$$

where Ret and γ denote retention and decay factor, respectively. In essence, Sₙ conveniently maintains the previous internal states. Retention can also be defined in a parallel formulation per Equation 2.

$$Ret = ( q {k}^{⊤} ⊙ M ) v , \qquad Equation 2$$

where M denotes a mask with a decay factor γ as in Equation 3.

$${M}_{i j} = \{ \begin{matrix}{γ}^{i - j} , i \geq j \\ 0 , i < j\end{matrix} \} \qquad Equation 3$$

This dual representation of the retention in parallel and recurrent modes enables many desired properties, such as training parallelism and fast inference. For longer sequences, the recurrent mode can become inefficient. As a result, a hybrid approach, referred to as chunkwise, which combines recurrent and parallel formulation, may be used. Specifically, the input X is split into smaller sequences with chunk size C, in which X_{[m]}=[x_{(m-1)c+1}, . . . , x_{mC}] represents the m-th chunk. The chunkwise query, key, and values can be defined per Equation 4.

$${q}_{[ m ]} = {q}_{Cm : C ( m + 1 )} , \qquad Equation 4$$

$${k}_{[ m ]} = {k}_{Cm : C ( m + 1 )} ,$$

$${v}_{[ m ]} = {v}_{Cm : C ( m + 1 )} .$$

The chunkwise retention formulation is per Equation 5.

$${R}_{m} = {k}_{[ m ]}^{⊤} ( {v}_{[ m ]} ζ ) + {γ}^{B} {R}_{m - 1} , \qquad Equation 5$$

$$Ret ( {X}_{[ m ]} = ( {q}_{[ m ]} {k}_{[ m ]}^{⊤} ⊙ M ) {v}_{[ m ]} + ( {q}_{[ m ]} {R}_{m - 1} ) ⊙ ξ ,$$

$${ξ}_{mt} = {γ}^{m + 1} , {ζ}_{mt} = {γ}^{B - m - 1} .$$

The chunkwise formulation employs the parallel mode in each chunk while processing cross-chunk representations in the recurrent mode. For high-resolution images with long sequences, the chunkwise formulation allows for faster processing of tokens and decoupling the memory.

### 2D Retention

The 1D formulation can be expanded to achieve shift equivariance. Under 1D formulation, the decay between successive patches of the image along a column of the image is increased by a constant factor γ (gamma). The 2D formulation extends the decay to both horizontal and vertical dimensions simultaneously, applying the decay factor γ raised to the power of the sum of non-negative offsets in both directions (Δx′+Δy′).

### 2D Recurrent Formulation

Given a point (x, y), Equation 1 is rewritten in the functional form r(x, y) in order to parameterize the position within the sequence with both x and y coordinates, with x, y ∈ [symbol] +, which can be formulated per Equation 6.

$$r ( x + f , y ) = … + {γ}^{f} r ( x , y ) + … \qquad Equation 6$$

$$r ( x , y + g ) = … + {γ}^{g} r ( x , y ) + …$$

The L1 distance between position (x+f, y+g) and (x, y) as the decay rate which results in Equation 7.

$$r ( x + f , y + g ) = … {γ}^{x - f + y - g )} r ( x , y ) + … \qquad Equation 7$$

The autoregressive property of retention is preserved, thus enforcing that f, g≥0. Furthermore, the formulation of 2D retention in the recurrent form is formatted per Equation 8.

$$r ( 1 , 1 ) = {k}_{1 , 1}^{⊤} {v}_{1 , 1} \qquad Equation 8$$

$$r ( x , 1 ) = γ r ( x - 1 , 1 ) + {k}_{x , 1}^{⊤} {v}_{x , 1}$$

$$r ( 1 , y ) = γ r ( 1 , y - 1 ) + {k}_{1 , y}^{⊤} {v}_{1 , y}$$

$$r ( x , y ) = γ r ( x - 1 , y ) + γ r ( x , y - 1 ) - {γ}^{2} r ( x - 1 , y - 1 ) + {k}_{x , y}^{⊤} {v}_{x , y}$$

The first 3 terms of Equation 8 can be seen as base cases in the recursion. In fact, r(x, 1) and r(1, y) take on the identical form of the original retention formulation. The r(x, y) form still allows for computing r(x, y) with constant time complexity as is computes a sum over a fixed number of terms (r(x−1, y), r(x, y−1), r(x−1, y−1).

### 2D Parallel Formulation

For the convenience of notation, let ∇x=x−f and ∇y=y−g for some f≤x and g≤y, and x, y, f, g ∈ [symbol] ⁺. Given this, the parallel formulation is introduced per Equation 9.

$$p ( x , y ) = {\sum }_{g = 1}^{y} {\sum }_{f = 1}^{x} {γ}^{( Δ x + Δ y )} {k}_{f , g}^{⊤} {v}_{f , g} \qquad Equation 9$$

It is also more apparent how the L1 distance underpins the decay rate as it is directly applied in the parallel formulation. To construct the full decay mask for the parallel formulation, the complete sequence of tokens s ∈ S is introduced, and the position within, and then x′(s)=s mod W and y′(s)=└s/W┘. Hence, Δx′=x′(c)−x′(r) and Δy′=y′(c)−y′(r). As a result, the mask is represented per Equation 10.

$${M}_{rc} = \{ \begin{matrix}{γ}^{( Δ {x}^{′} + Δ {y}^{′} )} , Δ {x}^{′} \geq 0 , Δ {y}^{′} \geq 0 \\ 0 , otherwise\end{matrix} \qquad Equation 10$$

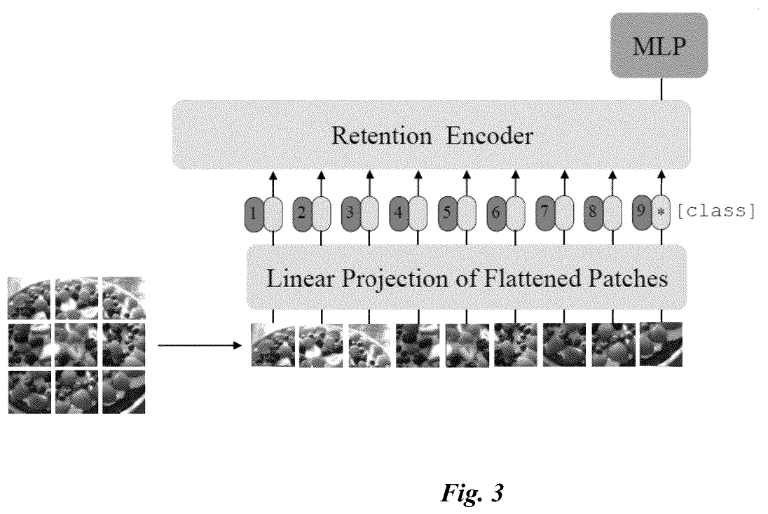

FIG. 3 illustrates an architecture of a computer vision model having dual parallel and recurrent formulations, in accordance with an embodiment. The computer vision model described herein may be implemented in the context of the computer vision model mentioned in FIGS. 1 and/or 2 above.

Given an input image X ∈ [symbol] ^{H×W×C} with height H and width W, it is partitioned into patches and flattened into a sequence of tokens. The tokenized patches are then projected into a patch embedding Z=[z₁, . . . , z_{|z|}]∈ [symbol] ^{|z|×D} with dimension D. The position embedding is first added to the patch embedding and then a [class] token (Zₙ^{o}=X_{class}) is appended thereto.

The output of the retention encoder with L layers (Z_{L}ⁿ is used in a classification MLP head during both pre-training and finetuning. Due to the autoregressive nature of the computer vision model, the position of the [class] plays an important role as appending to the end of the embedding sequence acts as a summarizing of all the previous tokens.

In lieu of self-attention, retention is used to enforce a recurrent formulation via masking. However, the formulation does not depend on gated retention or specific relative position embeddings and achieves numerical equivalency between parallel, recurrent and hybrid formulations. Specifically, the parallel retention formulation solely depends on query q, key k, value v and a decay Mask M as defined according to Equation 11.

$$q , k , v = z {A}_{qkv} , \qquad Equation 11$$

$$Ret ( z ) = ( \frac{q {k}^{⊤}}{\sqrt{{D}_{h}}} ⊙ M ) v ,$$

where Ret represents retention and Dₕ is a scaling factor to balance the compute and parameter counts.

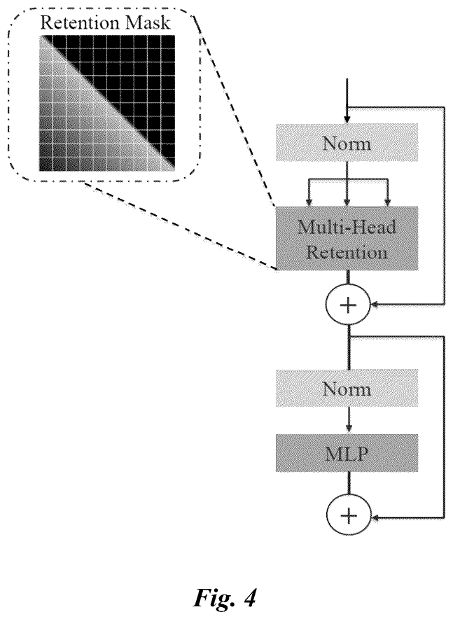

FIG. 4 illustrates an architecture of the retention encoder of the computer vision model of FIG. 3, in accordance with an embodiment. As shown, the retention (Ret) is further extended to Multi-Head Retention (MHR). The retention is computed across each head with a constant decay factor and normalized with LayerNorm (LN) according to Equation 12.

$$Y = L N ( [ R e {t}_{1} ( z ) ; … {Ret}_{k} ( z ) ] ) . \qquad Equation 12$$

The retention encoder includes alternating MHR and MLP blocks with LN and residual connections according to Equation 13.

$${Z}^{′ l} = MH R ( L N ( {Z}^{′} ) ) + {Z}^{l - 1} , \qquad Equation 13$$

$${Z}^{′ l} = ML P ( L N ( {Z}^{′ l} ) ) + {Z}^{′ l}$$

The above description provides an example of an isotropic implementation of the computer vision model. In another possible implementation, the computer vision model may have a multi-scale architecture with multiple (e.g. four) stages with different resolutions. In this implementation, the higher-resolution features are processed in the initial (e.g. first two) stages that comprise convolutional neural network (CNN)-based blocks with residual connections. Specifically, given an input h), it is defined per Equation 14.

$$\hat{h} = GELU ( BN ( {Conv}_{3 \times 3} ( h ) ) ) , \qquad Equation 14$$

$$H = BN ( C o n {v}_{3 \times 3} ( \hat{h} ) ) + h$$

Where Conv_{3×3} is a dense 3×3 convolutional layer and BN denotes batch normalization. The lower resolution stages comprise of similar retention blocks as described with respect to the isotropic implementation above.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

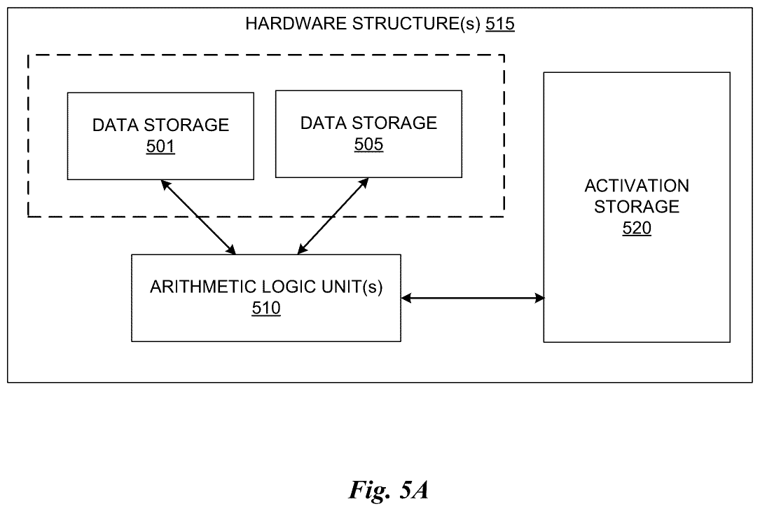

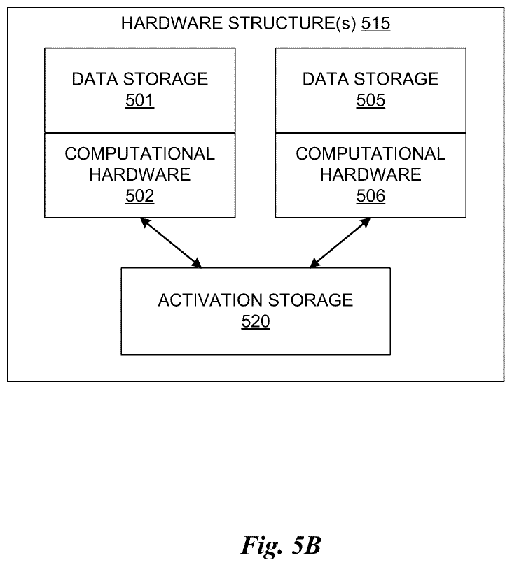

As noted above, a deep learning or neural learning system needs to be trained to generate inferences from input data. Details regarding inference and/or training logic 515 for a deep learning or neural learning system are provided below in conjunction with FIGS. 5A and/or 5B.

In at least one embodiment, inference and/or training logic 515 may include, without limitation, a data storage 501 to store forward and/or output weight and/or input/output data corresponding to neurons or layers of a neural network trained and/or used for inferencing in aspects of one or more embodiments. In at least one embodiment data storage 501 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 501 may be included with other on-chip or off-chip data storage, including a processor's L1, L2, or L3 cache or system memory.

In at least one embodiment, any portion of data storage 501 may be internal or external to one or more processors or other hardware logic devices or circuits. In at least one embodiment, data storage 501 may be cache memory, dynamic randomly addressable memory (“DRAM”), static randomly addressable memory (“SRAM”), non-volatile memory (e.g., Flash memory), or other storage. In at least one embodiment, choice of whether data storage 501 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 515 may include, without limitation, a data storage 505 to store backward and/or output weight and/or input/output data corresponding to neurons or layers of a neural network trained and/or used for inferencing in aspects of one or more embodiments. In at least one embodiment, data storage 505 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 505 may be included with other on-chip or off-chip data storage, including a processor's L1, L2, or L3 cache or system memory. In at least one embodiment, any portion of data storage 505 may be internal or external to on one or more processors or other hardware logic devices or circuits. In at least one embodiment, data storage 505 may be cache memory, DRAM, SRAM, non-volatile memory (e.g., Flash memory), or other storage. In at least one embodiment, choice of whether data storage 505 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 501 and data storage 505 may be separate storage structures. In at least one embodiment, data storage 501 and data storage 505 may be same storage structure. In at least one embodiment, data storage 501 and data storage 505 may be partially same storage structure and partially separate storage structures. In at least one embodiment, any portion of data storage 501 and data storage 505 may be included with other on-chip or off-chip data storage, including a processor's L1, L2, or L3 cache or system memory.

In at least one embodiment, inference and/or training logic 515 may include, without limitation, one or more arithmetic logic unit(s) (“ALU(s)”) 510 to perform logical and/or mathematical operations based, at least in part on, or indicated by, training and/or inference code, result of which may result in activations (e.g., output values from layers or neurons within a neural network) stored in an activation storage 520 that are functions of input/output and/or weight parameter data stored in data storage 501 and/or data storage 505. In at least one embodiment, activations stored in activation storage 520 are generated according to linear algebraic and or matrix-based mathematics performed by ALU(s) 510 in response to performing instructions or other code, wherein weight values stored in data storage 505 and/or data 501 are used as operands along with other values, such as bias values, gradient information, momentum values, or other parameters or hyperparameters, any or all of which may be stored in data storage 505 or data storage 501 or another storage on or off-chip. In at least one embodiment, ALU(s) 510 are included within one or more processors or other hardware logic devices or circuits, whereas in another embodiment, ALU(s) 510 may be external to a processor or other hardware logic device or circuit that uses them (e.g., a co-processor). In at least one embodiment, ALUs 510 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 501, data storage 505, and activation storage 520 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 520 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 520 may be cache memory, DRAM, SRAM, non-volatile memory (e.g., Flash memory), or other storage. In at least one embodiment, activation storage 520 may be completely or partially within or external to one or more processors or other logical circuits. In at least one embodiment, choice of whether activation storage 520 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 515 illustrated in FIG. 5A may be used in conjunction with an application-specific integrated circuit (“ASIC”), such as Tensorflow® Processing Unit from Google, an inference processing unit (IPU) from Graphcore™M, or a Nervana® (e.g., “Lake Crest”) processor from Intel Corp. In at least one embodiment, inference and/or training logic 515 illustrated in FIG. 5A may be used in conjunction with central processing unit (“CPU”) hardware, graphics processing unit (“GPU”) hardware or other hardware, such as field programmable gate arrays (“FPGAs”).

FIG. 5B illustrates inference and/or training logic 515, according to at least one embodiment. In at least one embodiment, inference and/or training logic 515 may include, without limitation, hardware logic in which computational resources are dedicated or otherwise exclusively used in conjunction with weight values or other information corresponding to one or more layers of neurons within a neural network. In at least one embodiment, inference and/or training logic 515 illustrated in FIG. 5B may be used in conjunction with an application-specific integrated circuit (ASIC), such as Tensorflow® Processing Unit from Google, an inference processing unit (IPU) from Graphcore™M, or a Nervana® (e.g., “Lake Crest”) processor from Intel Corp. In at least one embodiment, inference and/or training logic 515 illustrated in FIG. 5B may be used in conjunction with central processing unit (CPU) hardware, graphics processing unit (GPU) hardware or other hardware, such as field programmable gate arrays (FPGAs). In at least one embodiment, inference and/or training logic 515 includes, without limitation, data storage 501 and data storage 505, which may be used to store weight values and/or other information, including bias values, gradient information, momentum values, and/or other parameter or hyperparameter information. In at least one embodiment illustrated in FIG. 5B, each of data storage 501 and data storage 505 is associated with a dedicated computational resource, such as computational hardware 502 and computational hardware 506, respectively. In at least one embodiment, each of computational hardware 506 comprises one or more ALUs that perform mathematical functions, such as linear algebraic functions, only on information stored in data storage 501 and data storage 505, respectively, result of which is stored in activation storage 520.

In at least one embodiment, each of data storage 501 and 505 and corresponding computational hardware 502 and 506, respectively, correspond to different layers of a neural network, such that resulting activation from one “storage/computational pair 501/502” of data storage 501 and computational hardware 502 is provided as an input to next “storage/computational pair 505/506” of data storage 505 and computational hardware 506, in order to mirror conceptual organization of a neural network. In at least one embodiment, each of storage/computational pairs 501/502 and 505/506 may correspond to more than one neural network layer. In at least one embodiment, additional storage/computation pairs (not shown) subsequent to or in parallel with storage computation pairs 501/502 and 505/506 may be included in inference and/or training logic 515.

### Neural Network Training and Deployment

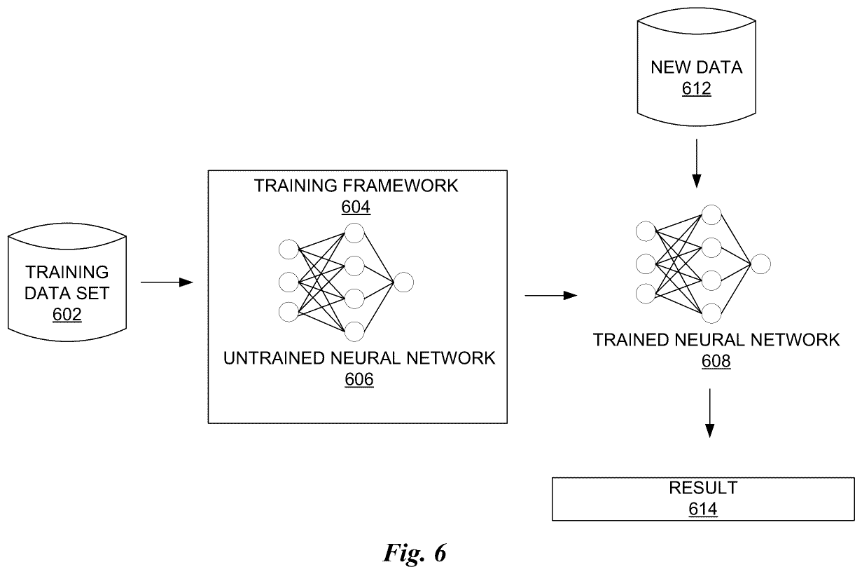

FIG. 6 illustrates another embodiment for training and deployment of a deep neural network. In at least one embodiment, untrained neural network 606 is trained using a training dataset 602. In at least one embodiment, training framework 604 is a PyTorch framework, whereas in other embodiments, training framework 604 is a Tensorflow, Boost, Caffe, Microsoft Cognitive Toolkit/CNTK, MXNet, Chainer, Keras, Deeplearning4j, or other training framework. In at least one embodiment training framework 604 trains an untrained neural network 606 and enables it to be trained using processing resources described herein to generate a trained neural network 608. In at least one embodiment, weights may be chosen randomly or by pre-training using a deep belief network. In at least one embodiment, training may be performed in either a supervised, partially supervised, or unsupervised manner.

In at least one embodiment, untrained neural network 606 is trained using supervised learning, wherein training dataset 602 includes an input paired with a desired output for an input, or where training dataset 602 includes input having known output and the output of the neural network is manually graded. In at least one embodiment, untrained neural network 606 is trained in a supervised manner processes inputs from training dataset 602 and compares resulting outputs against a set of expected or desired outputs. In at least one embodiment, errors are then propagated back through untrained neural network 606. In at least one embodiment, training framework 604 adjusts weights that control untrained neural network 606. In at least one embodiment, training framework 604 includes tools to monitor how well untrained neural network 606 is converging towards a model, such as trained neural network 608, suitable to generating correct answers, such as in result 614, based on known input data, such as new data 612. In at least one embodiment, training framework 604 trains untrained neural network 606 repeatedly while adjust weights to refine an output of untrained neural network 606 using a loss function and adjustment algorithm, such as stochastic gradient descent. In at least one embodiment, training framework 604 trains untrained neural network 606 until untrained neural network 606 achieves a desired accuracy. In at least one embodiment, trained neural network 608 can then be deployed to implement any number of machine learning operations.

In at least one embodiment, untrained neural network 606 is trained using unsupervised learning, wherein untrained neural network 606 attempts to train itself using unlabeled data. In at least one embodiment, unsupervised learning training dataset 602 will include input data without any associated output data or “ground truth” data. In at least one embodiment, untrained neural network 606 can learn groupings within training dataset 602 and can determine how individual inputs are related to untrained dataset 602. In at least one embodiment, unsupervised training can be used to generate a self-organizing map, which is a type of trained neural network 608 capable of performing operations useful in reducing dimensionality of new data 612. In at least one embodiment, unsupervised training can also be used to perform anomaly detection, which allows identification of data points in a new dataset 612 that deviate from normal patterns of new dataset 612.

In at least one embodiment, semi-supervised learning may be used, which is a technique in which in training dataset 602 includes a mix of labeled and unlabeled data. In at least one embodiment, training framework 604 may be used to perform incremental learning, such as through transferred learning techniques. In at least one embodiment, incremental learning enables trained neural network 608 to adapt to new data 612 without forgetting knowledge instilled within network during initial training.

### Data Center

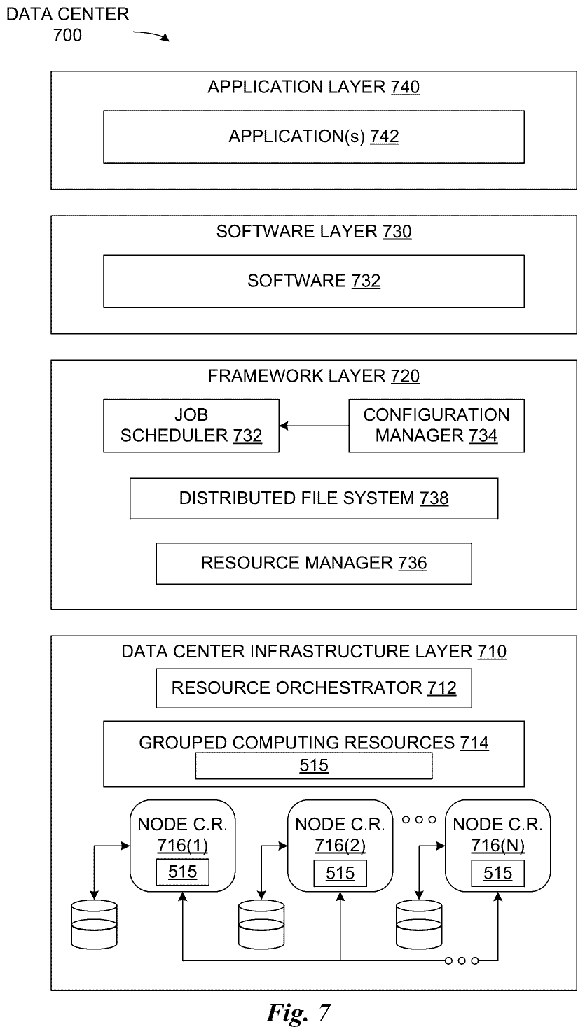

FIG. 7 illustrates an example data center 700, in which at least one embodiment may be used. In at least one embodiment, data center 700 includes a data center infrastructure layer 710, a framework layer 720, a software layer 730 and an application layer 740.

In at least one embodiment, as shown in FIG. 7, data center infrastructure layer 710 may include a resource orchestrator 712, grouped computing resources 714, and node computing resources (“node C.R.s”) 716(1)-716(N), where “N” represents any whole, positive integer. In at least one embodiment, node C.R.s 716(1)-716(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 716(1)-716(N) may be a server having one or more of above-mentioned computing resources.

In at least one embodiment, grouped computing resources 714 may include separate groupings of node C.R.s housed within one or more racks (not shown), or many racks housed in data centers at various geographical locations (also not shown). Separate groupings of node C.R.s within grouped computing resources 714 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 722 may configure or otherwise control one or more node C.R.s 716(1)-716(N) and/or grouped computing resources 714. In at least one embodiment, resource orchestrator 722 may include a software design infrastructure (“SDI”) management entity for data center 700. In at least one embodiment, resource orchestrator may include hardware, software or some combination thereof.

In at least one embodiment, as shown in FIG. 7, framework layer 720 includes a job scheduler 732, a configuration manager 734, a resource manager 736 and a distributed file system 738. In at least one embodiment, framework layer 720 may include a framework to support software 732 of software layer 730 and/or one or more application(s) 742 of application layer 740. In at least one embodiment, software 732 or application(s) 742 may respectively include web-based service software or applications, such as those provided by Amazon Web Services, Google Cloud and Microsoft Azure. In at least one embodiment, framework layer 720 may be, but is not limited to, a type of free and open-source software web application framework such as Apache Spark™ (hereinafter “Spark”) that may utilize distributed file system 738 for large-scale data processing (e.g., “big data”). In at least one embodiment, job scheduler 732 may include a Spark driver to facilitate scheduling of workloads supported by various layers of data center 700. In at least one embodiment, configuration manager 734 may be capable of configuring different layers such as software layer 730 and framework layer 720 including Spark and distributed file system 738 for supporting large-scale data processing. In at least one embodiment, resource manager 736 may be capable of managing clustered or grouped computing resources mapped to or allocated for support of distributed file system 738 and job scheduler 732. In at least one embodiment, clustered or grouped computing resources may include grouped computing resource 714 at data center infrastructure layer 710. In at least one embodiment, resource manager 736 may coordinate with resource orchestrator 712 to manage these mapped or allocated computing resources.

In at least one embodiment, software 732 included in software layer 730 may include software used by at least portions of node C.R.s 716(1)-716(N), grouped computing resources 714, and/or distributed file system 738 of framework layer 720. one or more types of software may include, but are not limited to, Internet web page search software, e-mail virus scan software, database software, and streaming video content software.

In at least one embodiment, application(s) 742 included in application layer 740 may include one or more types of applications used by at least portions of node C.R.s 716(1)-716(N), grouped computing resources 714, and/or distributed file system 738 of framework layer 720. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 734, resource manager 736, and resource orchestrator 712 may implement any number and type of self-modifying actions based on any amount and type of data acquired in any technically feasible fashion. In at least one embodiment, self-modifying actions may relieve a data center operator of data center 700 from making possibly bad configuration decisions and possibly avoiding underutilized and/or poor performing portions of a data center.

In at least one embodiment, data center 700 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 700. In at least one embodiment, trained machine learning models corresponding to one or more neural networks may be used to infer or predict information using resources described above with respect to data center 700 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

As described herein, a method, computer readable medium, and system are disclosed to provide a dual formulated computer vision model. In accordance with FIGS. 1-4, embodiments may provide the dual formulated computer vision model usable for performing inferencing operations and for providing inferenced data. The computer vision model may be stored (partially or wholly) in one or both of data storage 501 and 505 in inference and/or training logic 515 as depicted in FIGS. 5A and 5B. Training and deployment of the computer vision model may be performed as depicted in FIG. 6 and described herein. Distribution of the computer vision model may be performed using one or more servers in a data center 700 as depicted in FIG. 7 and described herein.

What is claimed is:

1. A method, comprising:
at a device:
processing an input representation of an image, using a retention encoder of a computer vision model operating in accordance with a first formulation that at least in part includes a recurrent formulation, to generate an encoded representation of the image, wherein the computer vision model has been trained with the retention encoder operating in accordance with a second formulation that is a parallel formulation; and
processing the encoded representation of the image, using a multilayer perceptron (MLP) of the computer vision model, to generate an output particular to a defined computer vision task.

2. The method of claim 1, wherein the retention encoder includes a multi-head retention component.

3. The method of claim 2, wherein the multi-head retention component uses a causal retention decay mask.

4. The method of claim 1, wherein the retention encoder includes at least one layer comprised of a multi-head retention component and a multilayer perceptron (MLP) component.

5. The method of claim 4, wherein the retention encoder includes a plurality of layers each comprised of the multi-head retention component and the MLP component.

6. The method of claim 1, wherein the first formulation includes only the recurrent formulation.

7. The method of claim 6, wherein only the recurrent formulation is used for the first formulation when processing of the input representation of the image by the retention encoder satisfies a performance criteria.

8. The method of claim 1, wherein the first formulation includes a combination of the parallel formulation and the recurrent formulation.

9. The method of claim 8, wherein the combination of the parallel formulation and the recurrent formulation is used for the first formulation when processing of the input representation of the image by the retention encoder does not satisfy a performance criteria.

10. The method of claim 8, wherein the combination of the parallel formulation and the recurrent formulation is a chunkwise formulation that includes:
apportioning the input representation of the image into a plurality of portions,
using the parallel formulation to compute retention between the plurality of portions, and
using the recurrent formulation to compute retention within each portion of the plurality of portions.

11. The method of claim 1, wherein the recurrent formulation computes retention based on at least one previous state.

12. The method of claim 1, wherein the parallel formulation computes retention without regard to at least one previous state.

13. The method of claim 1, wherein the input representation of the image is a sequence of patch and position embeddings having a class token appended at an end of the sequence.

14. The method of claim 1, wherein the retention encoder is configured for one-dimensional (1D) retention.

15. The method of claim 14, wherein for the 1D retention decay between successive patches of the image along a column of the image is increased by a factor that is a number of patches per-row in the image.

16. The method of claim 1, wherein the retention encoder is configured for two-dimensional (2D) retention.

17. The method of claim 16, wherein for the 2D retention decay between successive horizontal and vertical patches of the image is maintained.

18. The method of claim 1, wherein the defined computer vision task is object detection and instance segmentation.

19. The method of claim 1, wherein the defined computer vision task is semantic segmentation.

20. A system, comprising:
a non-transitory memory storage comprising instructions; and
one or more processors in communication with the memory, wherein the one or more processors execute the instructions to:
process an input representation of an image, using a retention encoder of a computer vision model operating in accordance with a first formulation that at least in part includes a recurrent formulation, to generate an encoded representation of the image, wherein the computer vision model has been trained with the retention encoder operating in accordance with a second formulation that is a parallel formulation; and
process the encoded representation of the image, using a multilayer perceptron (MLP) of the computer vision model, to generate an output particular to a defined computer vision task.

21. The system of claim 20, wherein the retention encoder includes a multi-head retention component.

22. The system of claim 21, wherein the multi-head retention component uses a causal retention decay mask.

23. The system of claim 20, wherein the retention encoder includes at least one layer comprised of a multi-head retention component and a multilayer perceptron (MLP) component.

24. The system of claim 23, wherein the retention encoder includes a plurality of layers each comprised of the multi-head retention component and the MLP component.

25. The system of claim 20, wherein the recurrent formulation computes retention based on at least one previous state.

26. The system of claim 20, wherein the parallel formulation computes retention without regard to at least one previous state.

27. The system of claim 20, wherein the retention encoder is configured for one-dimensional (1D) retention.

28. The system of claim 20, wherein the retention encoder is configured for two-dimensional (2D) retention.

29. The system of claim 20, wherein the defined computer vision task is object detection and instance segmentation.

30. The system of claim 20, wherein the defined computer vision task is semantic segmentation.

31. A non-transitory computer-readable media storing computer instructions which when executed by one or more processors of a device cause the device to:
process an input representation of an image, using a retention encoder of a computer vision model operating in accordance with a first formulation that at least in part includes a recurrent formulation, to generate an encoded representation of the image, wherein the computer vision model has been trained with the retention encoder operating in accordance with a second formulation that is a parallel formulation; and
process the encoded representation of the image, using a multilayer perceptron (MLP) of the computer vision model, to generate an output particular to a defined computer vision task.

32. The non-transitory computer-readable media of claim 31, wherein the recurrent formulation computes retention based on at least one previous state.

33. The non-transitory computer-readable media of claim 31, wherein the parallel formulation computes retention without regard to at least one previous state.

34. The non-transitory computer-readable media of claim 31, wherein the retention encoder is configured for one-dimensional (1D) retention.

35. The non-transitory computer-readable media of claim 31, wherein the retention encoder is configured for two-dimensional (2D) retention.

36. The non-transitory computer-readable media of claim 31, wherein the defined computer vision task is object detection and instance segmentation.

37. The non-transitory computer-readable media of claim 31, wherein the defined computer vision task is semantic segmentation.
